(19) United States
(12) Patent Application Publication
(10) Pub. No.: US 2014/0334910 A1
(43) Pub. Date: Nov. 13, 2014

(54) ROLLER LIFT HANDLE SYSTEM

(71) Applicant: Jason R. Raasch, Cedarburg, WI (US)

(72) Inventor: Jason R. Raasch, Cedarburg, WI (US)

(73) Assignee: Briggs & Stratton Corporation, Wauwatosa, WI (US)

(21) Appl. No.: 13/889,877

(22) Filed: May 8, 2013

(51) Int. Cl. B62B 3/02

(52) U.S. Cl. CPC B62B 3/02
USPC 414/800; 280/43.17

(57) ABSTRACT

A roller lift handle system moves a roller between a raised roller position in which the roller elevates a support post above the underlying terrain and a lowered roller position in which the support post contacts the underlying terrain.

### BACKGROUND

Equipment such as generators, pressure washers or pumps are often characterized as being “portable”. However, even such “portable” equipment is often heavy and awkward to move. Equipment provided with wheels may be undesirably subject to movement during operation of the equipment.

### BRIEF DESCRIPTION OF THE DRAWINGS

FIG. 1 is a rear perspective view of an example carrier.

FIG. 2A is a right side view of the carrier of FIG. 1 in a stationary state.

FIG. 2B is a right side view of the carrier of FIG. 1 in process of being actuated to a transport state.

FIG. 2C is a right side view of the carrier of FIG. 1 in the transport state.

FIG. 3 is a rear perspective view of another example carrier.

FIG. 4A is a right side view of the carrier of FIG. 3 in a stationary state.

FIG. 4B is a right side view of the carrier of FIG. 3 in process of being actuated to a transport state.

FIG. 4C is a right side view of the carrier of FIG. 3 in the transport state.

FIG. 5 is a rear perspective view of another example carrier.

FIG. 6A is a right side view of the carrier of FIG. 5 in a stationary state.

FIG. 6B is a right side view of the carrier of FIG. 5 in process of being actuated to a transport state.

FIG. 6C is a right side view of the carrier of FIG. 5 in the transport state.

### DETAILED DESCRIPTION OF THE EXAMPLE EMBODIMENTS

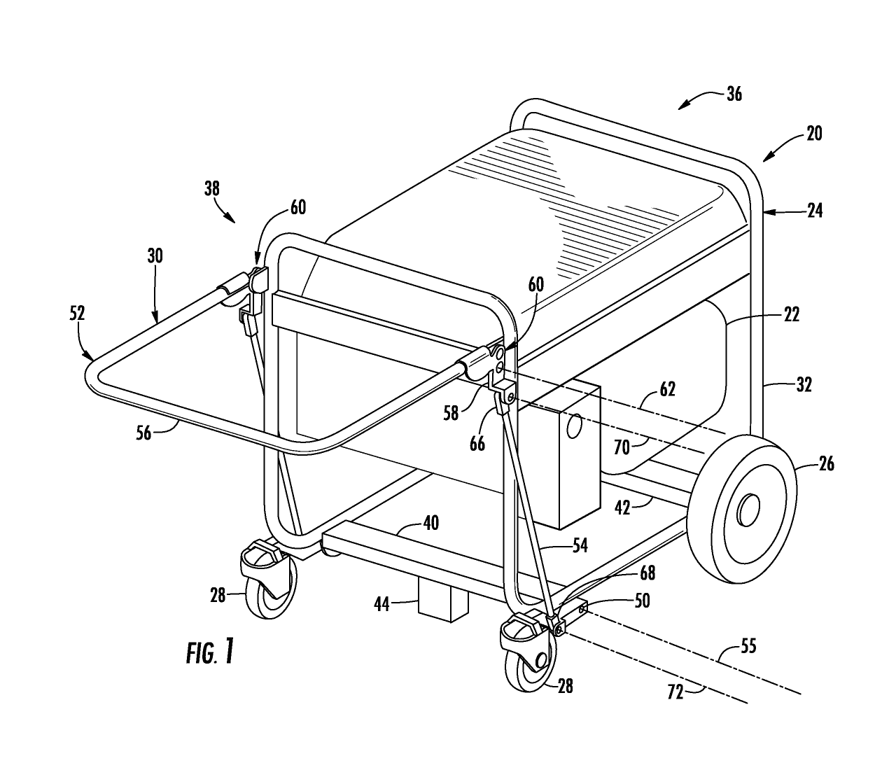

FIG. 1 illustrates an example carrier 20 supporting in carrying an example powered equipment 22. As will be described hereafter, carrier 20 is actuatable between different positions or states. In a first transport state, carrier 20 facilitates the transport of equipment or other relatively heavy articles or machinery. In a second stationary state, carrier 20 interacts with the underlying terrain to inhibit accidental movement of carrier 20.

In the example illustrated, the piece of powered equipment 22 carried or supported by carrier 20 comprises a gasoline powered piece of equipment. In another implementation, powered equipment 22 comprises an electrically powered piece of equipment. In the example illustrated, powered equipment 22 comprises a gasoline or other fuel powered generator. In other implementations, powered equipment 22 may comprise other types of equipment such as a pressure washer, pump, vacuum, air compressor or the like.

Carrier 20 comprises frame or body 24, wheels 26, rollers 28 and roller lift handle system 30. Frame or body 24 comprises one or more structures which form a foundational structure for supporting equipment 22. In the example illustrated, frame or body 24 elevates and suspends equipment 22. In another implementation, frame or body 24 alternatively provides a floor or platform upon which equipment 22 rests and/or is mounted. In the example illustrated, body 24 comprises a rectangular frame or cart formed from a bar or tube 32 extending in a rectangular shape, wherein short ends of the rectangle are bent upwardly to form a front 36 and a rear 38 of the cart. In the example illustrated, body 24 further comprises a pair of crossbars 40, 42 rigidifying and strengthening carrier 20. In the example illustrated, body 24 further comprises a leg, projection, foot or post 44 configured to extend into engagement with the ground or underlying terrain when wheels 28 are raised by roller lift handle system 30 and to be lifted or raised out of engagement with the ground or underlying terrain when wheels 28 are deployed or lowered by roller lift handle system 30. When in the ground engaging state, post 44 stabilizes carrier 22 against movement. In one implementation, post 44 comprises a rubber-like or treaded ground gripping sole or bottom to increase frictional gripping of the underlying terrain and reduce the likelihood of unintended movement of carrier 20. In the raised or elevated state, post 44 does not contact the underlying terrain such that body 24 is elevated supported above ground solely by wheels 26, 28, allowing easier transport of carrier 20 and its contents, equipment 22. Although post 44 is illustrated as a single post, in other implementations, post 44 may comprise a plurality of spaced ground engaging posts. In some implementations, post 44 may be omitted, wherein a bottom portion of body 24, proximate to rear 38, contacts the ground or underlying terrain when wheels 28 are raised to stabilize carrier 20 against movement.

Wheels 26 facilitate movement and transport of carrier 20 when wheels 28 are deployed. Wheels 26 are rotationally coupled to and supported by body 24 proximate to front 36 at each front corner of carrier 20. In other implementations, other mechanisms to facilitate forward movement of body 24 relative to the underlying ground, such as track members or skis may be used. In the example illustrated, wheels 26 are supported by body 24 so as to always be in contact with the underlying ground. In another implementation, wheels 26, similar to rollers 28, may be operably coupled to body 24 by another roller lift handle system or a mechanism which operates similar to the roller lift handle system 30, allowing wheels 26 to be pivoted or otherwise actuated between a lowered deployed stator position in which wheels 26 elevate the front 36 of carrier 20 and a raised position in which forces a body 24 proximate to front 36 are permitted to contact the underlying terrain or ground to inhibit movement of carrier 20 relative to the underlying ground or terrain.

Although carrier 20 is illustrated as including a pair of spaced wheels along opposite sides of body 24, in other implementations, carrier 20 may include a greater number of wheels or rollers proximate a front 36. In another implementation, carrier 20 may include a single wheel or roller 26 supported at a central location between the lateral sides of body 24. In such an alternative implementation, carrier 20 having a three-wheel configuration provided by the two rearward, spaced rollers 28 and the front center roller or wheel 26.

Rollers 28 comprise cylindrical or circular members rotatably supported and coupled to body 24 by roller lift handle system 30. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members. Rollers 28 are carried by row lift handle system 30. When deployed, wheels 28 facilitate movement of carrier 20 and transport of equipment 22. As will be described hereafter, in other implementations, carrier 20 may alternatively include a single centered roller 28 when using combination with a pair of forward spaced wheels 26 to provide a three-wheel configuration.

Roller lift handle system 30 couples wheels 28 to body 24 and actuates or moves wheels 28 between a lowered deployed position or state which rollers 28 elevate body 24 above the underlying terrain and a raised position in which body 24 is lowered into contact with the underlying terrain. Roller lift handle system 30 further comprises a handle or means for manually grasping carrier 20 to steer, push or pull carrier 20. In the example illustrated, roller lift handle system 30 pivots rollers 28 between the raised position and the lowered position.

Roller lift handle system comprises arms 50, lift handle 52 and link 54. Lift arms 50 carry and rotationally support rollers 28 while being pivotably coupled to body 24 for rotation about axis 55. In the example illustrated, each of arms 50 extends along an outside of body 24. In another implementation, arms 50 may be located on an inside of body 24.

Lift handle 52 comprises one or more structures operably coupled to arms 50 and configured such that a person may grasp and exert force upon lift handle 52 to raise or lift rollers 28 or to lower rollers 28 into a deployed state or position. Lift handle 52 further comprises one or more structured by which a person may grasp when steering, pushing or pulling carrier 20 when rollers 28 are lowered or deployed. In implementations where powered mechanisms are utilized to propel carrier 20, lift handle 52 may serve to steer carrier 20 as carrier 20 is being propelled under power. In other implementations, lift handle 52 may further be utilized for manual pushing or pulling of carrier 20. In the example illustrated, lift handle 52 comprises handle portion 56 and extension 58. Handle portion 56 comprises a U-shaped rod or bar having end portions 60 pivotably coupled to body 24 for pivotal movement about axis 62. Extension 56 comprises a structure obliquely extending from handle portion 56 for connection to link 54. In the example illustrated, etc. 56 extends perpendicular from handle portion 56 such that lift handle 52 is generally L-shaped.

Links 54 comprise members operably coupling lift handle 52 to arms 50. Each of links 54 comprises a first end 66 pivotably coupled to extension 56 and a second opposite end 68 pivotably coupled to arm 50. End 66 is pivotally coupled to extension 56 for pivotal movement relative to extension 56 about axis 70. End 68 is pivotally coupled to arm 50 between axis 55 and the rotational axis of roller 28 for pivotal movement relative to arm 50 about axis 72. Link 54 operably coupled lift handle 56 and arm 50 such that rollers 28 pivot about axis 55 in response to pivoting of lift handle 56 about axis 62.

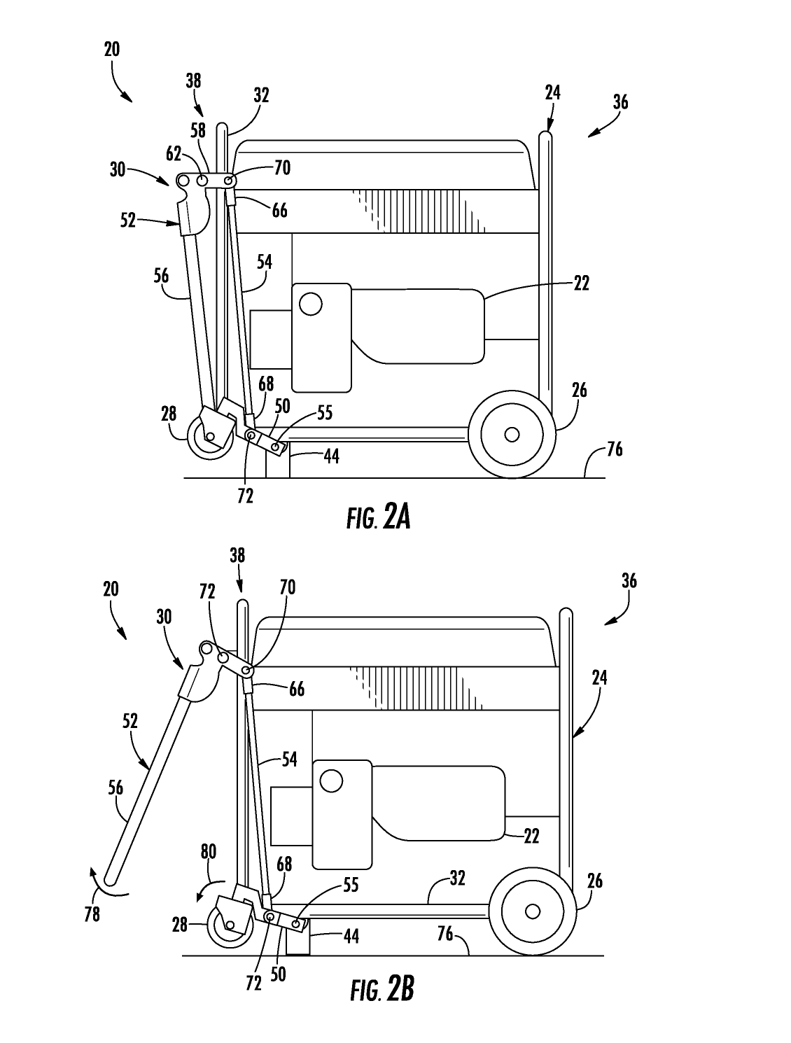

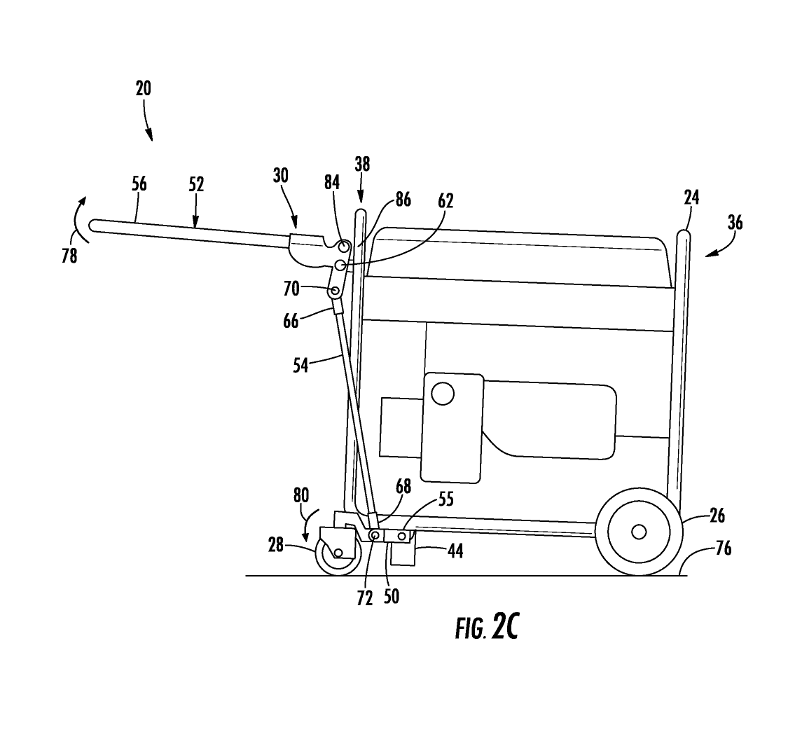

FIGS. 2A-2C illustrate operation of roller lift handle system 30. FIG. 2A illustrates carrier 20 in the stationary state in which handle portion 56 extends generally vertical, towards the ground or underlying terrain 76, in which rollers 28 are in a raised state off of terrain 76 and in which post 44 of body 24 rests against terrain 76 to inhibit movement of carrier 20 or rotation of wheels 26. As shown by FIG. 2A, when carrier 20 is in the illustrated stationary state, axis 70 is on a first side of axis 72.

In the example illustrated, the weight of lift handle 52 (largely the weight of handle portion 56) and the distance between a center of mass of lift handle 52 and axis 72 produce a counter-clockwise torque about axis 72 (as seen in FIG. 2A) that is greater than a clockwise torque about axis 72 produced by the weight of rollers 28, arms 50, links 54 and portions of extension 56 extending between link 54 and axis 72 and the distance between the center of mass of such components and axis 72. As a result, gravity assists in maintaining rollers 28 in the raised or elevated state that is shown in FIG. 2A. In other implementations, a clip, strap, actuatable bracket or other retaining mechanism may be used to releasably secure wheels 28 in the raised or elevated state. For example, a clip or bracket may extend from body 24 and releasably attached or clip onto a lower portion of handle portion 56 when handle portion 56 is in the vertical orientation shown. In yet other implementations, rollers may be permitted to fall under the force of gravity until contacting terrain 76. In such an implementation, rollers 28 would not support or elevate carrier 20, but would merely rest upon train 76 with the weight of carrier 20 (and equipment 22) be supported on terrain 76 by post 44.

FIG. 2B illustrates deployment of rollers 28 to the lowered state. To deploy rollers 28, handle portion 56 is lifted and pivoted about axis 78 in a clockwise direction as indicated by arrow 78. As a result, axis 70 also rotates in a clockwise direction about axis 62, driving link 54 in a downward direction. During movement of links 54, end 66 pivots relative to extension 56 about axis 70 while end 68 pivots relative to arm 50 about axis 64. This results in arms 50 pivoting about axis 55 in a counterclockwise direction about axis 55 (as seen in FIG. 2B) as indicated by arrow 80.

FIG. 2C illustrate rollers 28 in the fully lowered or deployed position in which rollers 28 bear against terrain 76 so as to support rear 38 of carrier 20 above terrain 76. When rollers 28 are in the lowered position, a bottom of post 44 is sufficiently elevated above terrain 76 so to not contact or engage terrain 76 during movement of carrier 20 across terrain 76. In the example illustrated, when rollers 28 are in the fully lowered or deployed position, handle portion 56 extends substantially horizontal. Handle portion 56 extends rearwardly beyond rollers 28 (in contrast to the state shown in FIG. 2A). As a result, a person may grasp handle portion 56 to push or pull carrier 20 and may take larger or complete walking strides, taking steps underneath lift handle 56 between a rearward most and portion of handle portion 56 and rollers 28. In other implementations, handle portion 56 may extend at other angular orientations and may project from rear 38 of body 24 by different extents when rollers 28 are fully deployed.

As further shown by FIG. 2C, when handle portion 56 is raised and rollers 28 are in the lowered deployed position, axis 70 is on a second opposite side of axis 62 as compared to when rollers 28 are in the raised position shown in FIG. 2A. As a result, downward movement of handle portion 56 is opposed by the weight of carrier 20 and equipment 22. In particular, for handle portion 56 to be lowered, and a portion 56 must rotate about axis 62 in a counter-clockwise direction. However, for such pivotal movement of handle portion 56 to occur, link 54 must be moved downwardly and arms 50 must pivot about axis 55, further lifting the weight of carrier 20. As a result, handle portion 56 is naturally maintained in the raised and extended position or state shown using gravity and this over-center arrangement. Inadvertent or accidental lowering of handle portion 56 is prevented. Further clockwise rotation or pivoting of handle portion 56 about axis 62 (as seen in FIG. 2C) is inhibited by one or more stop surfaces that engage lift handle 52 to limit clockwise rotation of lift handle 52. In the example illustrated, lift handle 52 comprise a stop surface 84 that abuts against an opposing stop surface 86 of body 24 to inhibit such further pivoting. In other implementations, the degree or extent to which lift handle 56 pivot once axis 70 has been moved rearwardly of axis 62 when rollers 28 are deployed may be limited by other stop surfaces or other mechanisms.

In other implementations, handle portion 56 may alternatively be maintained in the elevated a raised state by other mechanisms. For example, releasable latches, locks or other mechanisms may releasably retain handle portion 56 in the extended and raised state shown. In yet other implementations, handle portion 56 may have other configurations so to not project from rear 28 of body 24 when rollers 28 are deployed.

Once in the transport state shown in FIG. 2C, carrier 20 may be more easily pushed or pulled and relocated. Once at a desired location, handle portion 56 may once again be lowered and pivoted to the stationary state shown in FIG. 2A. In the stationary state, movement of carrier 20 is inhibited by interaction of post 44 with terrain 76. At the same time, handle portion 56 once again extends vertically the statue parallel to the rear 38 of body 24, reducing the size or area occupied by carrier 20 and allowing easier movement about carrier 20.

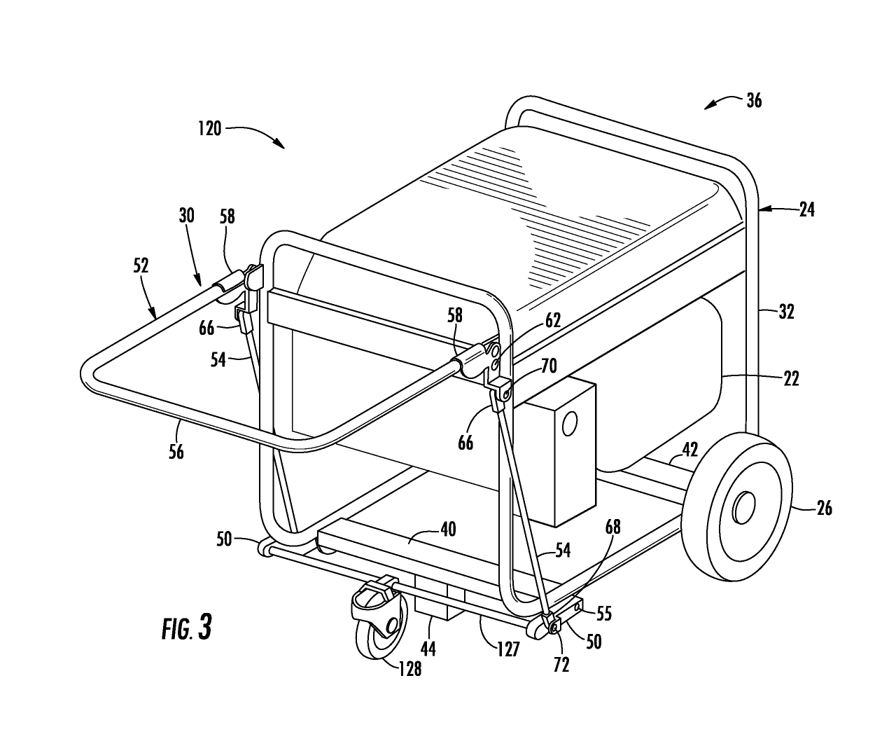

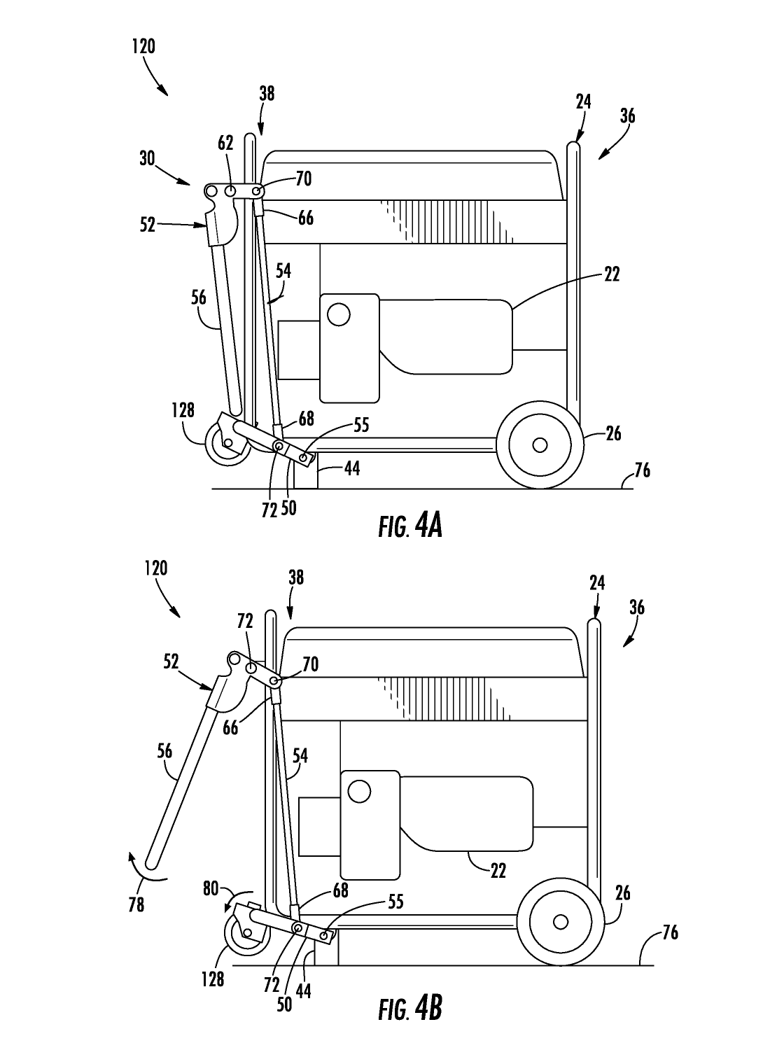

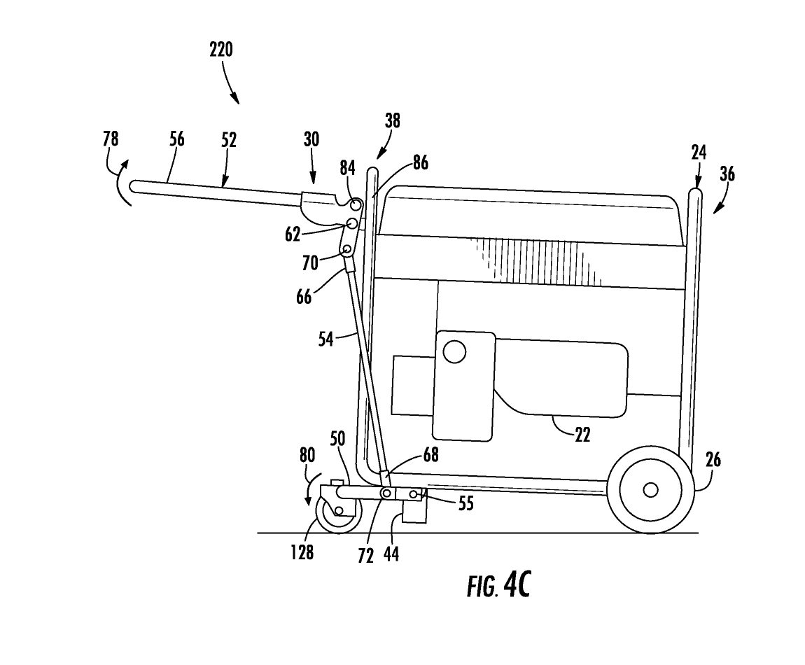

FIGS. 3 and 4A-4C illustrate carrier 120, another example implementation of carrier 20 shown in FIGS. 1 and 2A-2C. Carrier 120 is similar to carrier 20 in substantially all respects except that carrier 120 comprises support shaft 127 and roller 128 in lieu of rollers 28. Those remaining components of carrier 220 which correspond to components of carrier 20 are numbered similarly. Support shaft 127 comprises a shaft, rod or bar extending between and interconnecting arms 50. Support shaft 127 supports roller 128 at a central location between the opposite transverse sides of body 24 and between arms 50.

Roller 128 is similar to one of rollers 28 except the roller 128 is supported by support shaft 127. Roller 128 comprises a cylindrical or circular member rotatably supported and coupled to body 24 by support shaft 127 and roller lift handle system 30. As with rollers 28, roller 128 is moved between a lowered deployed position preference shown in FIG. 3) in a raised position by roller lift handle system 30.

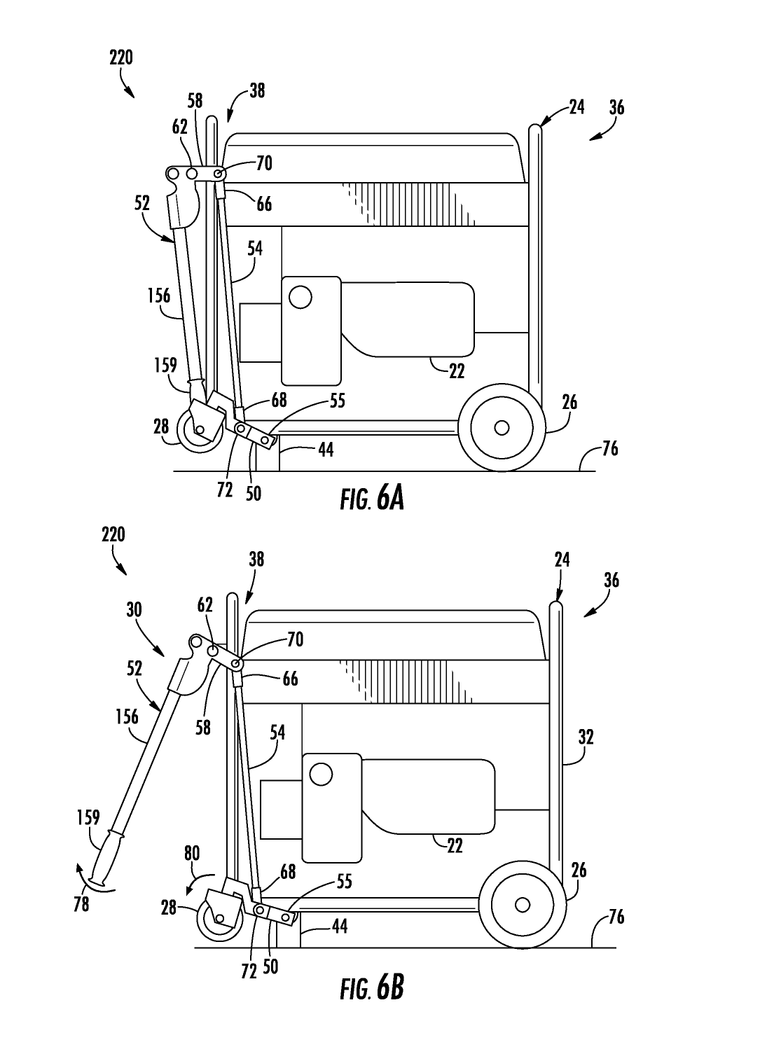

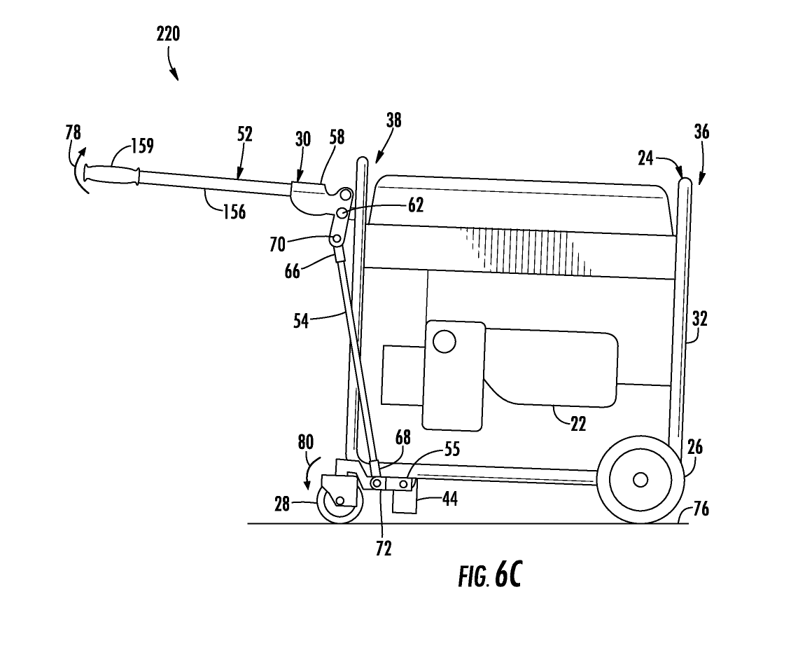

FIGS. 4A-4C illustrate operation of roller lift handle system 30. As shown by such figures, roller lift handle system 30, when employed in carrier 120, operates in a substantially similar fashion as to when roller lift handle system 30 is employed in carrier 20. In particular, raising of handle portion 56 pivots roller 128 from the raised position shown in FIG. 4A to the lowered, deployed position shown in FIG. 4C. As a result, carrier 220 is actuated from the stationary state shown in FIG. 6A to the transport state shown in FIG. 6C. Each of the above described movements and positions of roller lift handle system 30 with respect to carrier 20 occur the same with carrier 120.

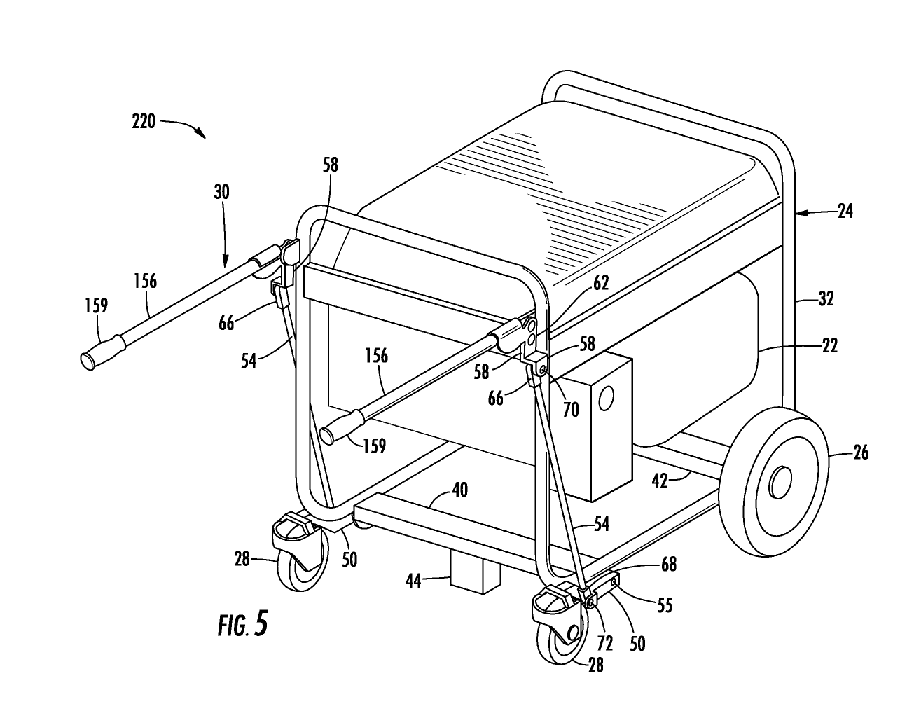

FIGS. 5 and 6A-6C illustrate carrier 220, another example implementation of carrier 20 shown in FIGS. 1 and 2A-2C. Carrier 220 is similar to carrier 20 in substantially all respects except that carrier 120 comprises handle portions 156 in lieu of handle portion 56. Those remaining components of carrier 220 which correspond to components of carrier 20 are numbered similarly. Handle portions 156 comprise separate spaced rods, bars or other elongate members extending from extension 58. Panel portions 156 each include a manual gripping portion 159 by which a person may grip and a portion to rural 156.

FIGS. 6A-6C illustrate operation of roller lift handle system 30 employed as part of carrier 220. As shown by such figures, roller lift handle system 30, when employed in carrier 120, operates in a substantially similar fashion as to when roller lift handle system 30 is employed in carrier 20. In particular, raising of handle portions 56 pivots rollers 28 from the raised position shown in FIG. 5A to the lowered deployed position shown in FIG. 5C. As a result, carrier 220 is actuated from the stationary state shown in FIG. 6A to the transport state shown in FIG. 6C. Each of the above described movements and positions of roller lift handle system 30 with respect to carrier 20 occur the same with carrier 220. Although handle portions 156 are illustrated with respect to system 220 including rollers 28, handle portions 156 may alternatively be employed as part of carrier 120 for moving or pivoting roller 128 between the lowered deployed position and the raised position.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a body;
a roller; and
a roller lift handle system comprising a lift handle that is moveably coupled to the body, wherein movement of the lift handle moves the roller between a lowered roller position in which the roller elevates the body above the underlying terrain and a raised roller position in which the body contacts the underlying terrain.

2. The apparatus of claim 1, wherein the lift handle extends vertical when the roller is in the raised roller position and horizontal when the roller is in the lowered roller position.

3. The apparatus of claim 1, where the roller lift handle system comprises:
an arm pivotably coupled to the body and carrying the roller; and
a link comprising a first end pivotally coupled to the lift handle and a second end pivotably coupled to the arm.

4. The apparatus of claim 3 further comprising a second roller rotatably supported and carried by the arm.

5. The apparatus of claim 3, wherein the lift handle extends vertical when the roller is in the raised roller position and horizontal when the roller is in the lowered roller position.

6. The apparatus of claim 4, wherein the lift handle extends beyond the roller when the roller is in the lowered roller position and between the roller and the body when the roller is in the raised roller position.

7. The apparatus of claim 4, wherein the lift handle is L-shaped.

8. The apparatus of claim 3, wherein the arm is pivotably coupled to the body about a first axis and wherein the link is pivotably coupled to the arm about a second axis between the roller and the first axis.

9. The apparatus of claim 10, wherein the lift handle is pivotally coupled to the body about a third axis and wherein the link is pivotably coupled to the lift handle about a fourth axis, the third axis located between the fourth axis and an outer gripping portion of the lift handle.

10. The apparatus of claim 9, wherein the fourth axis about which the link pivots relative to the lift handle rotates about the third axis from a first side of the third axis when the roller is in the raised roller position to a second side of the third axis when the roller is in the lowered roller position.

11. The apparatus of claim 1 further comprising a powered equipment supported by the body.

12. The apparatus of claim 1, wherein the body comprises a support post to contact underlying terrain and support a first portion of the body, wherein the apparatus further comprises a pair of wheels rotatably supporting a second portion of the body.

13. A method for comprising:
raising a lift handle to a raised handle position to lower a roller to elevate a body above the roller;
steering the body by manually applying force to the lift handle as the body rolls with the roller; and
lowering the lift handle to a lowered handle position to raise the roller above the body and to position the body against the ground to retain the body against movement.

14. The method of claim 13, wherein the raising and lowering of the lift handle comprised pivoting the lift handle.

15. The method of claim 13, wherein the lift handle extends vertical when the roller is in a raised roller position and horizontal when the roller is in a lowered roller position.

16. The method of claim 15, wherein the lift handle extends beyond the roller when the roller is in the lowered roller position and between the roller and the frame when the roller is in the raised position.

17. The method of claim 13, wherein the roller is carried by an arm coupled to the lift handle by a link, the method further comprising pivoting the arm about a first axis relative to the body by pivoting the link relative to the arm about a second axis between the roller and the first axis.

18. The method of claim 17, further comprising pivoting the lift handle about a third axis relative to the body and pivoting the link about a fourth axis relative to the lift handle, the third axis located between the fourth axis and an outer gripping portion of the lift handle.

19. The method of claim 18 further comprising moving the fourth axis from a first side of the third axis to a second side of the third axis to move the roller between a raised roller position and a lowered roller position.

20. An apparatus comprising:
a frame;
a pair of wheels rotatably supporting a first portion of the frame;
a support post to contact underlying terrain and support a second portion of the frame;
a roller; and
a roller lift handle system to move the roller between a raised roller position in which the roller elevates the support post above the underlying terrain and a lowered roller position in which the support post contacts the underlying terrain, an arm pivotably coupled to the frame and carrying the roller, the row lift handle system comprising:
an arm pivotably coupled to the frame about a first axis and carrying the roller, wherein the arm extends vertical when the roller is in the raised roller position and horizontal when the roller is in the lowered roller position;
a lift handle pivotably coupled to the frame about a second axis; and
a link comprising a first end pivotally coupled to the lift handle about a third axis and a second end pivotably coupled to the arm about a fourth axis, wherein the third axis is on a first side of the first axis when the roller is in the raised roller position and is on a second side of the first axis when the roller is in the lowered roller position.
